(19) United States
(12) Patent Application Publication
(10) Pub. No.: US 2019/0384925 A1
(43) Pub. Date: Dec. 19, 2019

(54) Document Production and Processing System

(71) Applicant: Wen-Hsing HSU, Hsinchu City (TW)

(72) Inventor: Wen-Hsing HSU, Hsinchu City (TW)

(21) Appl. No.: 16/059,106

(22) Filed: Aug. 9, 2018

(30) Foreign Application Priority Data
Jun. 15, 2018 (TW) 107120876

(51) Int. Cl. G06F 21/62; G06K 9/00; G06F 21/32; G06F 17/30

(52) U.S. Cl. CPC G06F 21/6209; G06K 9/00087; G06F 17/30011; G06F 21/32; G06K 9/00067

(57) ABSTRACT

Disclosed is a document production and processing system, comprising a document input device, a document editing device, a document storage device, a biometric feature input device and a biometric feature matching device. The document edition device obtains, before a document is edited, first biometric feature file from the document and requests second biometric feature file from a user. Unless the first and second biometric features are matched, the user is not allowed to access the document.

### TECHNICAL FIELDS OF THE INVENTION

The present invention relates to a document production and processing system. and more particularly to a document production and processing system based on fingerprint identification technology.

### BACKGROUND OF THE INVENTION

In modern times where almost all documents have been digitized and virtualized, the authenticity and security of documents have become an important issue. The authenticity requirement of the document is to ensure that the document maker or provider as specified is the same as the actual producer or provider. The security requirements of the document are to ensure that the document is not peeked or tampered by others during the provision and delivery of the document. Various solutions to provide authenticity and security of documents came into being.

U.S. Pat. No. 6,141,753 A, titled “Secure distribution of digital representations,” discloses a digital content production and processing method. All files of digital contents are provided to another, only when hidden watermarks are buried in the contents. The watermark contains the recipient's identification information and usage rights description. If abuse of digital content occurs, watermarks can be extracted from the abused digital content to confirm abuse and abuser.

U.S. Pat. No. 7,463,380 B2, titled “Spooling/despoiling subsystem job fingerprinting,” discloses a mechanism for implying a digital fingerprint in a print file. When the system prints documents, it will automatically generate “digital fingerprints” hidden in the printed image. The digital fingerprint will change the printed image, but the human eye cannot identify it. If the printed document is copied, the digital fingerprint will remain in the image and can be detected and recovered by a machine.

The use of fingerprint image identification technology in controlling the access and transmission of documents, to ensure safe applications, has been known to the industry.

Chinese Patent Publication CN 103544014A, titled “Fingerprint registration and authentication method for a property registration management system based on b/s,” discloses a rights registration method based on fingerprint authentication, and reads a new right holder's fingerprint, archived into the database, when filing the right holder's personal information. After the fingerprint is registered, the right holder can make various applications as long as his/her fingerprints are authenticated.

U.S. Patent Publication US 2005/0204173, titled “Method for automatically filling in user data using fingerprint identification,” discloses a web site login method based on fingerprint identification, wherein a user provides a fingerprint image upon registration to a web site. The fingerprint image is filed in the user's account on the web site. After registration, the user can automatically log in to the site as his or her own identity, by simply providing the fingerprint image.

U.S. Patent Publication US 2007/0279187, titled “Patient information storage and access,” discloses a medical data query system. Users must provide biometric data when applying for inquiries. The system compares the biometric data with the data recorded by the system, obtains the requested clothing data file, and provides a part of the data file to the user.

U.S. Pat. No. 9,378,348 entitled “Adding biometric identification to the server security infrastructure for an enterprise service bus system” discloses an access control mechanism. When users want to enter the corporate computer system, they must provide biometric data. The enterprise computer system provides the biometric data to a third-party authentication unit for identification. After the authentication is successful, the user is allowed to access the enterprise computer system.

U.S. Pat. No. 6,728,881, entitled “Fingerprint and signature identification and authorization card and pen,” discloses an access control key card. Cards can be inserted into a machine's card reader and the machine provides two fingerprint scanning windows and stores personal information of all cardholders. When a cardholder wants to use the machine, he/she inserts the key card into the machine's reader and scans his/her fingerprints. The access control mechanism of the machine matches the scanned fingerprint with the stored fingerprints and determines access of the user.

In the field of transaction security, U.S. Pat. No. 6,270,011 B2, entitled “Remote credit card authentication system,” discloses a credit card transaction security mechanism. After consumption in a store, credit card holders must provide fingerprint information when paying by credit card. The credit card issuer will approve the consumption after successful matching of the fingerprint data with the stored fingerprints.

The fingerprint image identification technology is also useful in the identity verification of document providers, in addition to the security control of document access and transmission.

Chinese Patent Publication CN 102833243, titled “A communication system using fingerprint data and its use,” discloses an information security mechanism used in communication application software. A first user of the communication application software needs to provide his/her fingerprint data when adding a second user as a friend. When accepting the invitation, the second user also needs to provide his/her fingerprint information. After successful joining as friends, when the first user transmits a message, his/her fingerprint data must first be extracted by a fingerprint sensor, whereby the server of the communication software authenticates the fingerprint data and sends the message content to the second user after successful authentication. After receiving the message, the second user needs to extract his/her fingerprint data with a fingerprint sensor for authentication, in order to read the message.

Chinese Utility Model CN 204833301 U, entitled “An electronic certificate acquisition device,” discloses a fingerprint data acquisition system. Each time a fingerprint is obtained, a time watermark is added to the fingerprint data file. The collected fingerprint data is sent to a server for storage. When the server receives fingerprint data, another time watermark is added to the file. This ensures the validity of the fingerprint data.

In addition, Chinese Patent Publication CN 105981039A, titled “Secure human fingerprint sensor,” discloses a fingerprint sensor for confirming that a fingerprint data file represents a live fingerprint. The fingerprinting machine provides a metal ring touch sensor. If the capacitive load of the metal ring is increased at the time of obtaining the fingerprint data, it is determined that the fingerprint data are actually obtained when the skin contacts the sensor.

U.S. Patent Publication US 2005/0063562 A1, entitled “Conveying fingerprint minutiae with digital watermarks,” discloses a method for adding fingerprint data in an identity document. The feature point location information of a fingerprint is processed and added to the photo on the ID document. An authentication device captures fingerprint feature point information from the photo and matches it with a fingerprint taken at the scene.

It can be known from the above description of the prior art that the industry has proposed various technologies and applications based on fingerprint image identification technology to ensure the authenticity and security of documents. For obtaining, storage and matching of fingerprint data, mature technologies have also been developed. However, the existing technology is mainly based on the technical principle of “fingerprint database.” When the fingerprint identification is performed, the fingerprint data to be identified is compared with the fingerprints stored in the fingerprint database. This comparison mechanism, although the identity of the fingerprint data provider can be determined, does not ensure the authenticity of the document. In addition, although the prior art has provided various biometric features identification technologies, including fingerprint identification technology, it did not make good use of the advantages of the biometric identification technologies.

### Objectives of the Invention

The objective of the present invention is to provide a novel document production and processing system and method that can ensure the authenticity of the produced document.

It is also an objective of the present invention to provide a document production and processing system and method based on the biometric identification technology.

### SUMMARY OF THE INVENTION

The document production and processing system according to the present invention mainly comprises a document production unit and a document processing unit. The two units can be arranged in the same computer device, and can also be arranged in different computer devices, especially in two distant computer devices, which are connected to each other by a communication network for data exchange.

The document production unit comprises:

a document input device for creating a document file or accepting an externally provided document file;

a document editing device for adding, deleting, or changing a content of a document input by the document input device;

a document storage device for storing contents of the document during or after edition of the document editing device and for providing the document for access; and

a biometric feature input device to obtain from a user a biometric feature data file describing at least one type of biometric feature; wherein the biometric feature is one selected from fingerprint, palm print, facial feature, palm shape, body shape, iris shape, voiceprint and gesture;

wherein, the document editing device is configured to automatically add a first biometric feature data file to the document file after the document file is edited.

In a preferred embodiment of the present invention, the document editing device is configured to request an input of the first biometric feature data file from the biometric feature input device after the document file is edited and to add the first biometric feature data file to the document file. In a particular embodiment of the present invention, the first biometric feature data may be a biometric feature data provided by a remote computer device.

In the embodiments of this invention, the document file is preferably a multimedia document file, that is, a document file that comprises at least two selected from the following elementary media: text, characters, numbers, formulas, images, sounds, and animations.

In the preferred embodiments of this invention, the biometric feature input device may further provide a biometric feature point extraction device to extract feature points description data contained in the biometrics descriptive file to generate the biometric feature data. In a particularly preferred embodiment of the present invention, the biometric feature input device is a fingerprint input device.

The document production unit may also include a document transmission device for connecting a remote computer device to provide a document file to the remote computer device or to obtain a document file from the remote computer device.

The document production unit may further include a document encryption device for automatically adding at least one encryption to a document file after edition.

The document processing unit comprises:

a document input device for creating a document file or accepting an externally provided document file; the document file being preferably a multimedia document file;

a document editing device for adding, deleting, or changing a content of a document input by the document input device;

a document storage device for storing contents of the document during or after edition of the document editing device and for providing the document for access;

a biometric feature input device to obtain from a user a biometric feature data file describing at least one type of biometric feature;

a biometric feature matching device to compare biometric feature of one biometric feature data file with biometric feature of another biometric feature data file of the same type using a biometric feature comparison method, and to output a result of “matched” of “not matched.”

In a preferred embodiment of the present invention, the biometric feature matching device is configured to compare distribution of feature points in two respective biometric feature data files and generate a result of “matched,” when similarity of the distribution exceeds a threshold value. In an advantageous embodiment of the present invention, the biometric feature matching device generates a result of “not matched,” when the distribution is identical or substantially the same, or when contents of two biometric feature data files are identical or substantially the same.

In the preferred embodiments of this invention, the document editing device is configured to: before editing a document file, retrieve the first biological feature data file from the document file, and request an input a second biological feature data file from the biometric feature input device, followed by actuating the biometric feature matching device to compare the second biometric feature data file with the first biometric feature data file; and to stop the document editing device to edit the document when the comparison result is “not matched.” The document editing device may also be configured to: before editing a document file, retrieve the first biological feature data file from the document file, and request a remote computer to provide a second biometric feature data file from a biometric feature input device for comparison.

In some preferred embodiments of the present invention, the document editing device may further be configured to automatically add into a document file a third biometric feature data file after editing of the document file. In one particularly preferred embodiment of the present invention, the document editing device is further configured to request an input of the third biometric feature data file from the biometric feature input device after editing of a document file that already contains the first biometric feature data file and add the third biometric feature data file in the document file.

The document processing unit may also include a document transmission device for connecting a remote computer device to provide a document file to the remote computer device or to obtain a document file from the remote computer device.

The document processing unit may further include a document decryption device for generating a decryption key. The document decryption device may be configured to generate a decryption key correspondence to the encryption when the comparison result of the biometric feature matching device is “matched.”

If both the document production unit and the document processing unit are installed in the same computer device, the common components and devices of the two can be shared. In addition, the document production and processing system of the present invention can also be constructed in the form of an application software and installed in an intelligent computing device, such as a personal computer, a tablet computer or a smart phone, to utilize the computing and storage capabilities of the intelligent computing device, as well as peripherals thereof, such as fingerprint input device and the like, to provide the various components required for the system of the present invention. The document production and processing method of the present invention can also utilize the intelligent computing device thus constructed to complete all the method steps.

These and other objectives, features and advantages of the present invention will become more apparent from the following detailed description of the invention when taken in conjunction with the accompanying drawings.

### BRIEF DESCRIPTION OF THE DRAWINGS

FIG. 1 shows the block diagram of an embodiment of the document production and processing system according to the present invention.

FIG. 2 is flowchart of an embodiment of the document production method according to the present invention.

FIG. 3 is flowchart of an embodiment of the document processing method according to the present invention.

FIG. 4 shows the block diagram of another embodiment of the document production and processing system of the present invention.

### DETAILED DESCRIPTION OF THE INVENTION

Several embodiments of the present invention will be described below with reference to the drawings. The invention relates to a document production and processing system and method, which uses the biometric comparison technology to ensure the safety and authentication of document production and processing.

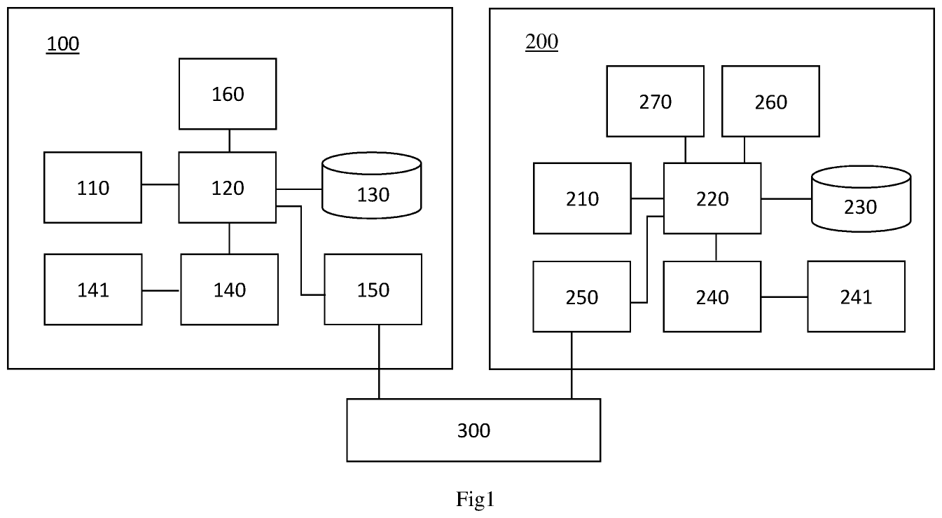

FIG. 1 shows the block diagram of an embodiment of the document production and processing system according to the present invention. As described above, the document production and processing system of the present invention can be constructed in the form of application software and installed in an intelligent computing device. Therefore, in the following description of the present embodiment, most of the components mentioned may be part of an intelligent computing device. As shown in the figure, the document production and processing system of the present invention mainly includes a document production unit 100 and a document processing unit 200. However, also as mentioned above, the two units can actually exist in one device at the same time, such as in an intelligent computing device. Therefore, if there are common components in both units, only one may be provided in the one computer device. In addition, the two units may also exist in two separate devices. In such an example, a document production and processing system usually consists of two separate units, a document production unit and a document processing unit.

As shown in FIG. 1, in the document production and processing system of the present invention, the document production unit 100 comprises: a document input device 110 for creating a document file or receiving an externally provided document file, a document editing device 120 for adding, deleting or changing contents of the document file, and a document storage device 130 for saving the contents of the document file during or after the document creation unit edits the document and for provide access of the document file.

Any device having the above structure and functions can be called a document production unit. Meanwhile, an apparatus having the above structure and functions may also be referred to as a document processing unit. Therefore, the document processing unit 200 shown in FIG. 1 also includes a document input device 210, a document editing device 220, and a document storage device 230. Their structure and functions are the same as or similar to that of the document input device 110, the document editing device 120, and the document storage device 130 of the document production unit 100, respectively.

In this sense, the document file is preferably a multimedia document file, that is, a document file that comprises at least two selected from the following elementary media: text, characters, numbers, formulas, images, sounds, and animations. However, the scope of application of the document production and processing system of the present invention is not limited to multimedia document files. General text files, image files, animation files, audio files, and the like are all suitable for production and processing using the present invention.

The document production unit 100 and the document processing unit 200 having the above-described structure and functions are already known technologies. Various commercially available hardware and software products can provide the required functions. For example, the document input device 110, 210 may be a general-purpose computer input device such as a keyboard, a tablet, a touch screen, a camera, a microphone, a card reader, a wireless transceiver, etc., or any combination thereof.

The document editing device 120, 220 may be an article editing software, an image editing software, an animation editing software, an audio document editing software, or a combination thereof, all built in a computer device. The document storage device 130, 230 may be an optical disk drive, a hard disk drive, a static hard disk, an external hard disk drive, a memory card. or a cloud server.

The document production and processing system of the present invention is equipped with a biometric feature input device 140, 240 in both the document production unit 100 and the document processing unit 200. The biometric feature input device 140, 240 is used to obtain from a user a biometric feature data file describing at least one type of biometric feature. The biometric feature data contained in the biometric feature data file describe the biometric feature in a particular digital format. Biometric features suitable for use in the present invention include: fingerprints, palm prints, face shapes, hand shapes, body shapes, iris shapes, voice prints, gestures, and the like. In most application examples of the present invention, only one type of biological feature needs to be used, while in certain embodiments, two or more types of biological features may be used. Therefore, the biometric feature input device 140, 240 may include a fingerprint input device, a palm scanner, a video camera, an image scanner, a sound receiver, etc., equipped with necessary software for obtaining biometric feature descriptive file input by a user using the fingerprint input device, the palm print machine, the camera, the image scanner, the sound receiver, etc., such as a fingerprint image, a palm print image, a face image, a conformal image, a body image, an iris image, a voiceprint data, a gesture image, or a hand gesture trajectory, followed by converting the biometric feature descriptive file into a particular digital format suitable for matching, to fonn the biometric feature data file. Biometric input devices having the above functions are already well-known in the industry, and there are a variety of commercially available products ready for use. The technical details thereof need not to be described here.

In most embodiments of the present invention, the biometric feature input device 140, 240 may provide a biometric feature point extraction device 141, 241 to extract feature points contained in the biometric feature data file, to generate a feature point descriptive data file. In these embodiments, the biometric feature data file is the feature point descriptive data file. This approach can reduce the amount of data in the biometric feature data file and has no negative impact on the correctness of the biometric feature data required for the present invention. In the preferred embodiments of the present invention, the biometric feature input device 140, 240 is a fingerprint input device. Therefore, the biometric feature data file may be a fingerprint data file or a fingerprint feature point data file. This is because fingerprint identification is the most commonly used biometric authentication technique but is not any technical limitation. Various fingerprint data obtaining, feature extraction, comparison and other related technologies are mature, and there are also many commercially available products available in the market.

According to the present invention, the document editing device 120 is configured to automatically add a first biometric feature data file to the document file after the document file is edited. In practice, in some preferred embodiments of the present invention, the document editing apparatus 120 is configured to request the user to input the first biometric feature data file using the biometric feature input device 140 after the document file is edited and to add the first biometric feature data file to the document file. In some other embodiments, the first biometric feature data may be a biometric feature data file provided by a remote computer device. In such embodiments, the document editing apparatus 120 is configured to request a remote computer device 300 to provide a biometric feature data file and use the remotely provided biometric feature data file as the first biometric feature data to be added to the document file.

The document production unit 100 may also include a document transmission device 150 for connecting a remote computer device 300 to provide a document file to the remote computer device or to obtain a document file from the remote computer device 300. In other words, with regard to the document production and processing system of the present invention, the document transmission device 150 can be used to obtain a document to be processed from the remote computer device 300, obtain a biometric feature data file, and to send out a processed document file. Devices with such document transmission capabilities can be any wired or wireless transceiver device. The related technology is already known.

The document production unit 100 may also include a file encryption device 160 for automatically adding at least one encryption to a document file after edition and generating a corresponding decryption key. This encryption technique is also a known technique and provides higher securities to the document file.

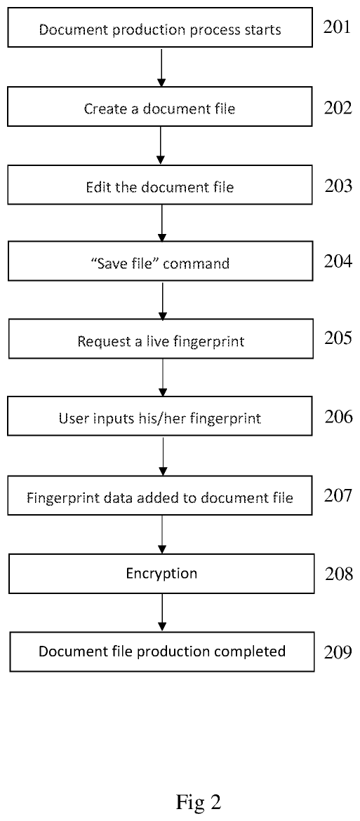

The document production unit 100 based on the above structure can be used to produce a document file which ensures the producer's identity data is authentic. FIG. 2 is a flow chart showing an example of how a document file is produced using the document production unit 100 of the present invention. As shown in the figure, the user starts the document production process of the document production and application system in step 201. The document editing device 120 is actuated at step 202 to create a document file in Microsoft Excel® format. The file name is “March Frankfurt 2018 Exhibition Report.” At 203, the user creates a flow chart describing the related preparation and participation activities of the user's colleagues, using the document input device 110, by entering a plurality of photos and text descriptions of each photo, entering images of business cards collected in the exhibition and keying in text contents describing the user's observations and suggestions as conclusions. At 204, the user completes the document production and presses a “save file” key. In step 205, the document editing device 120 activates the biometric feature input device 140 and displays the message “Please input your fingerprint” on the display. At 206, the user uses a finger, such as the right forefinger, to press the biometric feature input device 140, such as the fingerprint input device's input window, to input fingerprint image data. The fingerprint image data form a biometric feature descriptive file that contains information describing the fingerprint image of the right forefinger of the user. At 207, the biometric feature input device 140 retrieves the feature point position data from the fingerprint image data and includes them into a fingerprint feature data file as the first biometric feature data file and provides the first biometric feature data file to the document editing device 120 for adding to the document file. In some embodiments of the present invention, the document editing device 120 optionally activates the file encryption apparatus 160 at step 208 to perform encryption processing on the file. This completes the production of a document file. In step 209, the completed document file is stored in the document storage device 130. If the user wishes to transfer the file to other computers, the file transmission device 150 can be actuated at any time and the document file can be transmitted to the remote computer device 300.

In terms of document processing, as described above, the document processing unit 200 comprises a document input device 210, a document editing device 220, and a document storage device 230. In addition, the document processing unit 200 also comprises a biometric feature input device 240. These elements have the same or similar structure and functions as that of the corresponding elements used in the document production unit 100. Details thereof are thus omitted here.

The document processing device further comprises a biometric feature matching device 270 for comparing biometric feature of one biometric feature data file with biometric feature of another biometric feature data file of the same type using a biometric feature comparison method, and to output a result of“matched” of “not matched.” The “type” of biological feature referred to herein generally means the form or the origin of the biological feature. That is, a fingerprint feature data file must be compared with another file describing a fingerprint feature. And so on. In addition, the “biometric feature comparison method” refers to any method, technology or system that determines whether two biometric features originate from the same source. As a matter of fact, two biometric features of the same type originated from the same source won't be identical, if obtained at different time points. Therefore, biometric feature data obtain at different time points will only have a high degree of similarity. Under this premise, to determine whether the two biometric features of the same type originate from the same source, it is usually to determine the similarity in the distribution of the two biometric features, for example the patterns formed by the distribution, reaches a threshold value sufficient to be identified as being from the same source.

Accordingly, in the preferred embodiments of the present invention, the biometric feature matching device 270 is configured to determine two biometric features are “matched,” if the similarity in the distribution of their feature points, in particular the similarity of the two patterns formed by the feature points, is higher than a threshold. In the case of fingerprints, the fingerprint identification technology that determines whether two fingerprint images are from the same source based on the above-mentioned methodology has been described in many publications, and a variety of products are commercially available. Technical details thereof are thus omitted.

More particularly, in an advantageous embodiment of the present invention, the biometric feature matching device 270 determines two biometric features are “not matched,” if the two biometric features, such as two fingerprints, are identical or substantially identical. Although the present invention is not limited by any theory, the inventor found that the expression of biometric features varies from time to time. The performance of a biometric feature obtained by an input device at different times will not be the same or substantially the same. If the performance of two biometric features is exactly the same or substantially the same, that would be the result of copy or duplication of the biometric feature data file. Since it is a copy of the biometric feature data file, the result of “not matched” can be directly determined.

In addition to the technical features described above, the document editing device 220 used in the document processing unit 200 of the present invention is further configured to: before editing a document file, retrieve the first biological feature data file from the document file, and request the user to input a second biological feature data file using the biometric feature input device 240, or request a remote computer device to input a second biological feature data file using the biometric feature input device 240. The document editing device 220 is further configured to actuate the biometric feature matching device 270 to compare the second biometric feature data file with the first biometric feature data file; after the second biometric feature data file is obtained, and to stop the document editing device 220 to edit the document, when the comparison result is “not matched.”

Under the above design, the document editing apparatus 220 prevents the user from editing the document file, if the second biometric feature data file does not match, so to ensure that the document file is not tampered with by anyone other than the original author. To compare the first biometric feature data file with the second biometric feature data file from the originator at a remote computer, the authenticity of the received document file can be secured.

In addition, the document editing apparatus 220 can be additionally configured to automatically add into a document file a third biometric feature data file after editing of the document file. In practice, in a preferred embodiment of the present invention, the document editing device 220 is configured to request the user to input the third biometric feature data file using the biometric feature input device 240, after the edition of a document file that already contains the first biometric feature data file and add the third biometric feature data in the document file.

The document production unit 200 may also include a document transmission device 250 for connecting the remote computer device 300 to provide a document file to the remote computer device 300 or to obtain a document file from the remote computer device 300.

In addition, the document processing unit 200 may further comprise a document decryption device 260 for generating a decryption key. In this embodiment, the document decryption device 260 is configured to generate a decryption key corresponding to the encryption generated by the document encryption device 160, when the comparison result of the biometric feature matching device 270 is “matched.” Any known encryption and decryption technology can be used in this invention. The skilled person can easily use the commercially available products or known technologies to achieve the encryption and decryption requirements in the present invention.

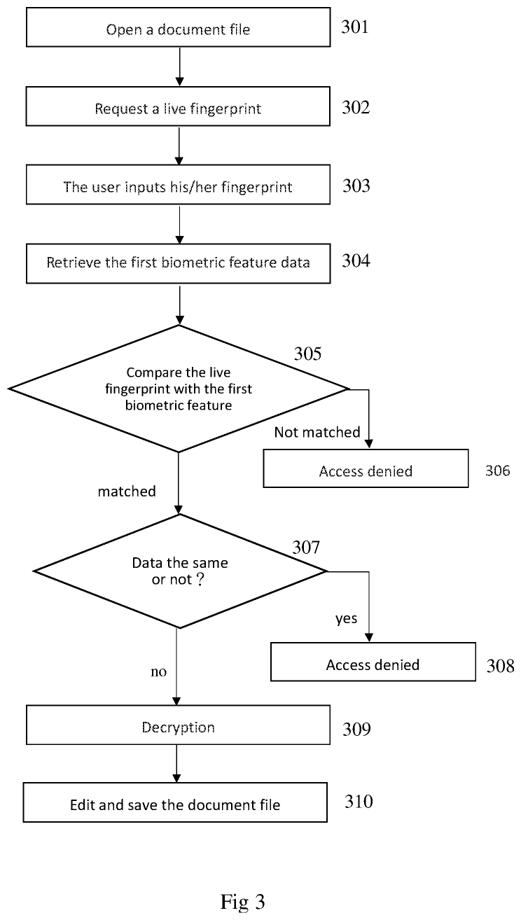

The document processing unit 200 based on the above-described architecture can be used to process a document file that ensures the producer's identity data is correct. FIG. 3 is a flow chart showing an example how a document file is processed using the document processing unit 200 of the present invention. As shown in the figure, in step 301, the user activates the document editing device 220 to edit a document file in the Microsoft Excel® format whose file name is “March Frankfurt 2018 Exhibition Report.” In step 302, the document editing device 220 activates the biometric feature input device 240 and displays the message “Please input your fingerprint” on the display. Alternatively, in step 302, the document editing apparatus 220 is connected to a remote computer device 300 to request a fingerprint data file, and the information of “Please input your fingerprint” is displayed on the display of the remote computer device 300. At 303, the user uses the biometric feature input device 240 to input the user's fingerprint image data, or the user of the remote computer device 300 inputs his/her fingerprint image data, i.e., the second biometric feature data file. At 304, the biometric feature matching device 270 retrieves the first biometric data file embedded in the document file from the document file, and compares it with the second biometric data file at step 305. If it is determined that the degree of similarity of the two fingerprint images does not exceed the threshold value, the operation of the document editing apparatus 220 is stopped at 306, and the message “You have no right to access this file” is displayed. As the degree of similarity determined in step 305 exceeds the threshold, at step 307 the biometric feature matching device further proceeds to determine whether the two biometric features are exactly the same or substantially the same. If the result of the determination of step 307 is positive, then the operation of the document editing apparatus 220 is stopped at 308 and the message “You do not have the right to access this file” is displayed. If the result of the determination in step 307 is negative, the document decryption device 260 is actuated in step 309 to decrypt the document file for the user to edit. After the edition is completed, the user press the “save” key at step 310. The document editing device 220 stores the completed document file in the document storage device 230 accordingly. If the user wishes to transmit the document file to other computers, the document transmission device 250 may be actuated at any time to transmit the file to the remote computer device 300.

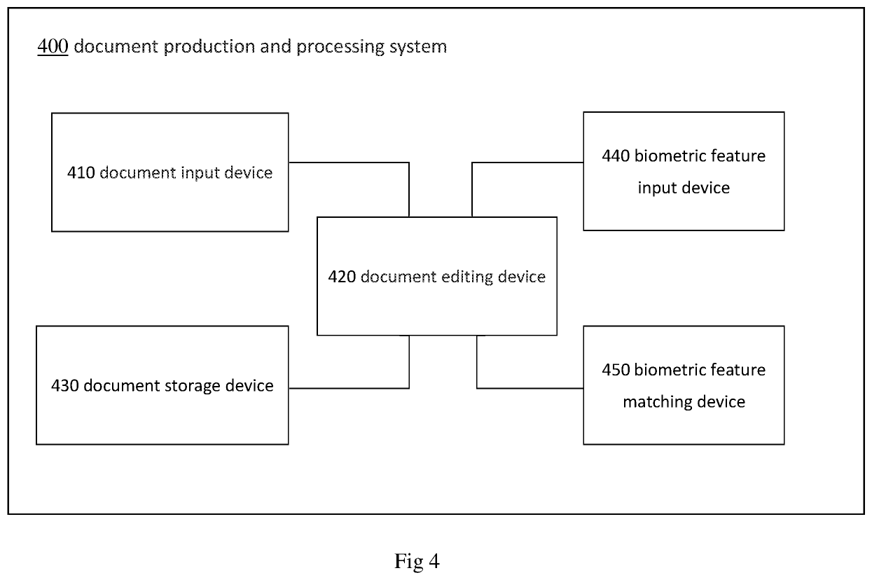

In some preferred embodiments of the present invention, the document production unit 100 and the document processing unit 200 are installed in the same computer device. In this embodiment, the common elements and components of the two can be shared. FIG. 4 shows a block diagram of a document production and processing system 400 according to this embodiment of the present invention. As shown in the figure, in this embodiment, the document production and processing system comprises:

a document input device 410 to create a document file or to accept an externally provided document file;

a document editing device 420 to add, delete or change contents of the document file;

a document storage device 430 to store the contents contained in the document file, during or after the document editing device 420 edits the document file, and to provide access of the document file;

a biometric feature input device 440 to obtain from a user a biometric feature data file describing at least one type of biometric feature; the biometric feature input device 440 can also provide a biometric feature point extraction device for extracting a plurality of feature points from the biometric feature data; and

a biometric feature matching device 450 to compare biometric feature of one biometric feature data file with biometric feature of another biometric feature data file of the same type using a biometric feature comparison method, and to output a result of “matched” of “not matched.”

The document editing device 420 is configured to automatically add a first biometric feature data file to the document file after the document file is edited. For example, the document editing device 420 may request the user to input the first biometric feature data file using the biometric feature input device 440 after the document file is edited and add the first biometric feature data file to the document file. Alternatively or additionally, the document editing device 420 may request a remote computer device (not shown) to provide the biometric feature data file, using a biometric feature input device provided in the remote computer device.

The document editing device 420 may be further configured to: before editing a document file, retrieve the first biological feature data file from the document file, and request the user to input a second biological feature data file using the biometric feature input device 440, followed by actuating the biometric feature matching device 450 to compare the second biometric feature data file with the first biometric feature data file; and to stop the document editing device 420 from editing the document when the comparison result is “not matched.” The user can be located either at the proximal end or at the distal end.

The document editing device 420 can be additionally configured to automatically add into a document file that already contains the first biometric feature data file a third biometric feature data file, after edition of the document file. For example, the document editing device 420 can request the user to input the third biometric feature data file using the biometric feature input device 440, after editing of a document file that already contains the first biometric feature data file and add the third biometric feature data file in the document file.

The method and process of producing and processing a document file using the document production and processing system of this embodiment are substantially the same as that of the embodiments of FIGS. 2 and 3. Details thereof are thus omitted.

In addition, the document production and processing system of the present invention can also be constructed in the form of an application software and installed in an intelligent computing device, such as a personal computer, a tablet computer, a smart phone etc., to utilize the computing and storage capabilities of the intelligent computing device, as well as its peripherals, such as the fingerprint input device, camera, image scanner and the like, to provide the various components required for in the system of the present invention. The document production and processing method of the present invention can also use the intelligent computing device thus constructed to complete all the method steps.

What is claimed is:

1. A document production and processing system, comprising:
a document input device to create a document file or to accept an externally provided document file;
a document editing device to add, delete or change contents of the document file;
a document storage device to store the contents contained in the document file, during or after the document editing device edits the document file, and to provide access of the document file;
a biometric feature input device to obtain from a user a biometric feature data file describing at least one type of biometric feature; and
a biometric feature matching device to compare biometric feature of one biometric feature data file with biometric feature of another biometric feature data file of the same type using a biometric feature comparison method, and to output a result of “matched” of “not matched;”
wherein the document editing device is configured to automatically add a first biometric feature data file to the document file after the document file is edited; and
wherein the document editing device is further configured to: before editing a document file, retrieve the first biological feature data file from the document file, and request an input of a second biological feature data file from the biometric feature input device, followed by actuating the biometric feature matching device to compare the second biometric feature data file with the first biometric feature data file; and to stop editing of the document file when the comparison result is “not matched.”

2. The system of claim 1, wherein the document editing device is configured to request an input of the first biometric feature data file from the biometric feature input device after the document file is edited and to add the first biometric feature data file to the document file.

3. The system of claim 1, wherein the document editing device is configured to request the first biometric feature data file from a biometric feature input device of a remote computer, after the document file is edited, and to add the first biometric feature data file to the document file.

4. The system of claim 1, wherein the biometric feature input device comprises a biometric feature point extraction device to extract feature points description data contained in the biometric feature to generate the biometric feature data.

5. The system of claim 4, wherein the biometric feature matching device compares a distribution of the feature points of two biometric feature data files to generate a “matched” result, when similarity of the distribution exceeds a threshold.

6. The system of claim 5, wherein the biometric feature matching device generates a result of “not matched,” if the distribution is identical or substantially identical.

7. The system of claim 1, wherein the biometric feature matching device generates a result of “not matched,” if contents of the two biometric feature data are identical or substantially identical.

8. The system of claim 1, wherein the document editing device is further configured to automatically add into a document file a third biometric feature data file, after editing of a document file already containing the first biometric feature data file.

9. The system of claim 8, wherein the document editing device is configured to request an input of the third biometric feature data file from the biometric feature input device after a document file already containing the first biometric feature is edited and to add the third biometric feature data file to the document file.

10. The system of claim 9, wherein the biometric feature input device comprises a biometric feature point extraction device to extract feature points description data contained in the biometric feature to generate the biometric feature data.

11. The system of claim 10, wherein the biometric feature matching device compares a distribution of the feature points of two biometric feature data files to generate a “matched” result, when similarity of the distribution exceeds a threshold.

12. The system of claim 11, wherein the biometric feature matching device generates a result of “not matched.” if the distribution is identical or substantially identical.

13. The system of claim 8, wherein the biometric feature matching device generates a result of “not matched,” if contents of the two biometric feature data are identical or substantially identical.

14. The system of claim 1, wherein the biometric feature is one selected from fingerprint, palm print, facial feature, palm shape, body shape, iris shape, voiceprint and gesture.

15. The system of claim 1, wherein the biometric feature input device is a fingerprint input device.

16. The system of claim 8, wherein the biometric feature input device is a fingerprint input device.

17. The system of claim 1, further comprising a document encryption device for automatically adding at least one encryption to a document file after editing.

18. The system of claim 17, further comprising a document decryption device configured to generate a decryption key corresponding to the encryption, when a comparison result of the biometric feature matching device is “matched.”

19. A document production and processing system comprising a document production unit and a document processing unit, provided in two computer devices linked by a communication network for data exchange, wherein
the document production unit comprises:
a document input device for creating a document file or accepting an externally provided document file;
a document editing device for adding, deleting, or changing a content of a document input by the document input device;
a document storage device for storing contents of the document during or after edition of the document editing device and for providing the document for access; and
a biometric feature input device to obtain from a user a biometric feature data file describing at least one type of biometric feature;
wherein the document editing device is configured to automatically add a first biometric feature data file to the document file after the document file is edited; and
the document processing unit comprises:
a document input device for creating a document file or accepting an externally provided document file;
a document editing device for adding, deleting, or changing a content of a document input by the document input device;
a document storage device for storing contents of the document during or after edition of the document editing device and for providing the document for access;
a biometric feature input device to obtain from a user a biometric feature data file describing at least one type of biometric feature; and
a biometric feature matching device to compare biometric feature of one biometric feature data file with biometric feature of another biometric feature data file of the same type using a biometric feature comparison method, and to output a result of “matched” of “not matched;”
wherein the document editing device is further configured to: before editing a document file, retrieve the first biological feature data file from the document file, and request an input of a second biological feature data file from the biometric feature input device, followed by actuating the biometric feature matching device to compare the second biometric feature data file with the first biometric feature data file; and to stop editing of the document file when the comparison result is “not matched.”

20. The system of claim 19, wherein the document editing device is configured to request an input of the first biometric feature data file from the biometric feature input device after the document file is edited and to add the first biometric feature data file to the document file.

21. The system of claim 19, wherein document editing device is configured to request the first biometric feature data file from a biometric feature input device of a remote computer, after the document file is edited and to add the first biometric feature data file to the document file.

22. The system of claim 19, wherein the biometric feature input device comprises a biometric feature point extraction device to extract feature points description data contained in the biometric feature to generate the biometric feature data.

23. The system of claim 22, wherein the biometric feature matching device compares a distribution of the feature points of two biometric feature data files to generate a “matched” result, when similarity of the distribution exceeds a threshold.

24. The system of claim 23, wherein the biometric feature matching device generates a result of “not matched,” if the distribution is identical or substantially identical.

25. The system of claim 19, wherein the biometric feature matching device generates a result of “not matched,” if contents of the two biometric feature data files are identical or substantially identical.

26. The system of claim 19, wherein the document editing device is further configured to automatically add into a document file a third biometric feature data file after editing of a document file already containing the first biometric feature data file.

27. The system of claim 26, wherein the document editing device is configured to request an input of the third biometric feature data file from the biometric feature input device after a document file already containing the first biometric feature data file is edited and to add the third biometric feature data file to the document file.

28. The system of claim 26, wherein the biometric feature input device comprises a biometric feature point extraction device to extract feature points description data contained in the biometric feature to generate the biometric feature data.

29. The system of claim 28, wherein the biometric feature matching device compares a distribution of the feature points of two biometric feature data files to generate a “matched” result, when similarity of the distribution exceeds a threshold.

30. The system of claim 29, wherein the biometric feature matching device generates a result of “not matched,” if the distribution is identical or substantially identical.

31. The system of claim 26, wherein the biometric feature matching device generates a result of “not matched.” if contents of the two biometric feature data files are identical or substantially identical.

32. The system of claim 19, wherein the biometric feature is one selected from fingerprint, palm print, facial feature, palm shape, body shape, iris shape, voiceprint and gesture.

33. The system of claim 19, wherein the biometric feature input device is a fingerprint input device.

34. The system of claim 26, wherein the biometric feature input device is a fingerprint input device.

35. The system of claim 19, wherein the document production unit further comprises a document encryption device for automatically adding at least one encryption to a document file after editing.

36. The system of claim 35, wherein the document processing unit further comprises a document decryption device configured to generate a decryption key corresponding to the encryption, when a comparison result of the biometric feature matching device is “matched.”
